(19) United States
(12) Patent Application Publication
(10) Pub. No.: US 2026/0320576 A1
(43) Pub. Date: Oct. 15, 2026

(54) AUTOMATED ACTIVATION MACHINE FOR USER EQUIPMENT

(71) Applicant: DISH Wireless L.L.C., Englewood, CO (US)

(72) Inventors: Stephen V. Bender, Littleton, CO (US); Adam Tyler Kratzer, Evergreen, CO (US)

(21) Appl. No.: 19/176,072

(22) Filed: Apr. 10, 2025

(51) Int. Cl. G06Q 20/18; G06F 8/61

(52) U.S. Cl. CPC G06Q 20/18; G06F 8/61

(57) ABSTRACT

Technologies for implementing an automated activation machine for user equipment that can be used in a cellular network are described. A system includes a user interface component; a receiving/delivering component; a robotics component; a device positioning component; an inventory component; one or more processing devices; and a memory communicatively coupled with and readable by the one or more processing devices and having stored therein processor-readable instructions which, when executed by the one or more processing devices, cause the one or more processing devices to perform operations including: receiving, via the user interface component, a request to order a first user equipment (UE); retrieving, via the robotics component, from the inventory component, the first UE according to an inventory identifier (ID); placing, via the robotics component, the first UE at a first place of the device positioning component; performing, via the robotics component, an activation process of the first UE; and delivering, via the robotics component, to the receiving/delivering component, the first UE.

### BACKGROUND

Customers often visit the retail stores of cellular network operators to shop for user equipment. There is a demand for simplifying the shopping process and making the shopping experience more efficient.

### BRIEF DESCRIPTION OF THE DRAWINGS

The present disclosure is illustrated by way of example, and not by way of limitation, in the figures of the accompanying drawings.

FIG. 1 is a block diagram of a system implementing an automated activation machine for user equipment that can be used in a cellular network according to at least one embodiment.

FIG. 2 illustrates an example process to use the automated activation machine for user equipment that can be used in a cellular network according to at least one embodiment.

FIGS. 3 and 4 are flow diagrams of example methods of implementing an automated activation machine for user equipment that can be used in a cellular network according to at least one embodiment.

### DETAILED DESCRIPTION

Technologies for implementing automated activation machine for user equipment that can be used in a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

The retail stores of cellular network operators are experiencing continued issues, such as staffing shortages and long wait times for customers. This is especially the case when the customers would like to purchase various user equipment or upgrade their user equipment.

Aspects and embodiments of the present disclosure address the above and other deficiencies by providing a system that implements an automated activation machine for user equipment that can be used in a cellular network. The automated activation machine may include various components to interact with user and to perform the user equipment (UE) activation process as requested by the user. Specifically, the automated activation machine may receive a request to order a new UE, such as mobile devices and accessories, that can be used in the cellular network. The automated activation machine may retrieve, from the inventory component of the machine, a UE corresponding to the request. The automated activation machine may place the retrieved UE in a place inside the machine (e.g., a first base provided by a positioning component of the machine) and perform the activation process of the UE. The activation process of the UE may involve powering up the UE, setting up a basic configuration of the UE, installing a set of default applications or software, setting up an account associated with the first UE, installing a set of customized applications or software according to the account, etc.

The automated activation machine may include a robotics component to perform various functions described herein to fulfill the request received from the user. The robotics component may include a scanning/recording tool, a movement tool, a processing tool, etc. The scanning/recording tool may scan the UE placed in the automated activation machine or record an image or video of the UE to inspect the UE. The movement tool may include robotic arms and/or robotic fingers to move the UE and/or interact with the UE to facilitate the performance of activation (or upgrade) process. The processing tool may process the data received from the scanning/recording tool and give the instructions to the movement tool. The details of the automated activation machine are illustrated later with examples.

After the activation process is completed, the automated activation machine may deliver the activated new UE to the user. In some cases, the automated activation machine gives the user an option of old UE trade-in, and when the user instructs the automated activation machine to trade in the old UE, the automated activation machine may retrieve the old UE from the user and place the old UE in another place inside the machine (e.g., a second base provided by a positioning component of the machine) to facilitate the activation process of the new UE, such as synchronizing the data stored in the new UE with the data stored in the old UE.

In some implementations, the automated activation machine may receive a request to upgrade a UE, such as mobile devices and accessories, that can be used in the cellular network. The automated activation machine may retrieve, from the user interaction component of the machine, the UE corresponding to the request. The automated activation machine may place the retrieved UE in a place inside the machine (e.g., a third base provided by a positioning component of the machine) and perform the upgrade process of the UE. In some implementations, the upgrade process may include all or partial of the activation process described herein. After the upgrade process is completed, the automated activation machine may deliver the upgraded UE to the user.

Aspects and embodiments of the present disclosure can use reduced human resources to render better customer experience and efficient service, including off-hour service. Aspects and embodiments of the present disclosure can simplify shopping process for customers and improve cost efficiency for retailers.

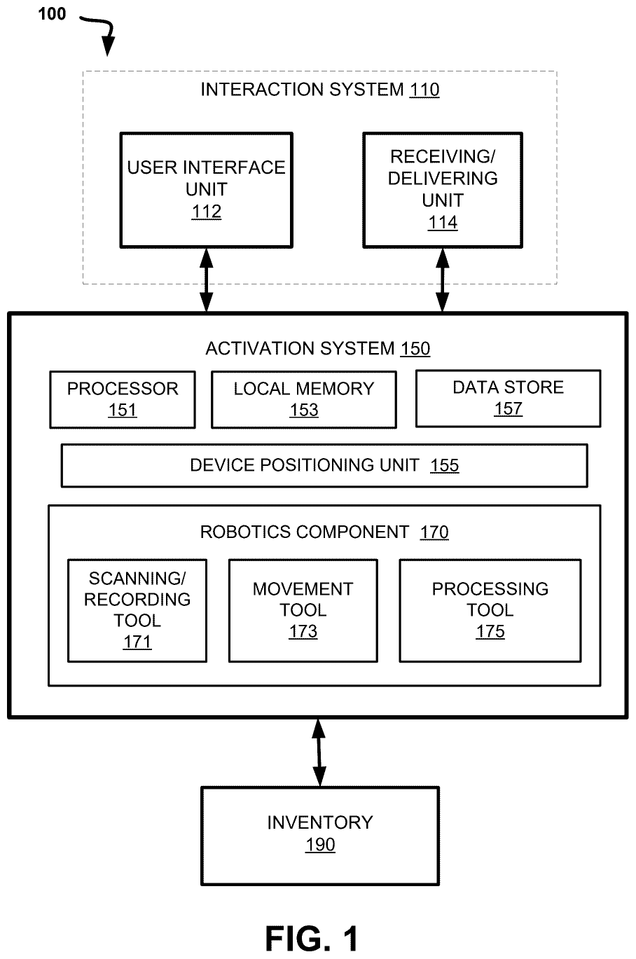

FIG. 1 illustrates a system implementing automated activation machine for user equipment (UE) that can be used in a cellular network. The UE can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. The UE may be any device that can use radio frequency (RF) to communicate with various base stations of cellular network, where the cellular network may include a 5G New Radio (NR) cellular network or other types of cellular networks, such as 6G, 7G, etc.

In some implementations, the system 100 may be a stand-alone device providing services on automated activation of UE in accordance with some embodiments of the present disclosure. The system 100 may include an interaction system 110 to interact with users (e.g., customers in a retail store), an activation system 150 to activate (or upgrade) UE, and an inventory 190.

The interaction system 110 may include one or more user interface units 112, such as touch screen, keypad, barcode scanner, card or document scanner, card reader, cash accepter, etc. The interaction system 110 may include one or more receiving/delivering units 114, such as UE acceptor, or UE dispenser. The interaction system 110 may further include the camera used for identity verification or video assistance, the printer used for receipt printing or document confirmation, the charging cord used for charging the UE, etc. The interaction system 110 may receive a user request regarding a service (e.g., including a service of purchasing a product) associated with a first UE, accept the first UE, and dispense a second UE (e.g., an upgraded first UE, or a new UE) according to the user request. The interaction system 110 can be coupled to the activation system 150 via a communication interface (e.g., a wired or wireless network interface). The interaction system 110 may communicate with the activation system 150 regarding the user request and UE.

The activation system 150 can include a computing system including a processing device and a software stack executable by the processing device. For example, the activation system 150 can include a processor 151 (e.g., processing device) configured to execute instructions stored in local memory 153. In the illustrated example, the local memory 153 of the activation system 150 includes an embedded memory configured to store instructions for performing various processes, operations, logic flows, and routines that control operation of the activation system 150, including handling communications between the interaction system 110 and the activation system 150, and communication between the inventory 190 and the activation system 150.

The activation system 150 may include a device positioning unit 155 that is capable of providing a designated surface, area, or space to position a UE. In some embodiments, the device positioning unit 155 may include a physical stand, a mounting bracket, a designated spot on a large base, etc. In some embodiments, the device positioning unit 155 may include one place to hold a UE received from the user (e.g., a first UE) via the interaction system 110 and another place to hold a new UE (e.g., a second UE) retrieved from the inventory 190. In some embodiments, the device positioning unit 155 may include multiple places, where each place holds a separate UE.

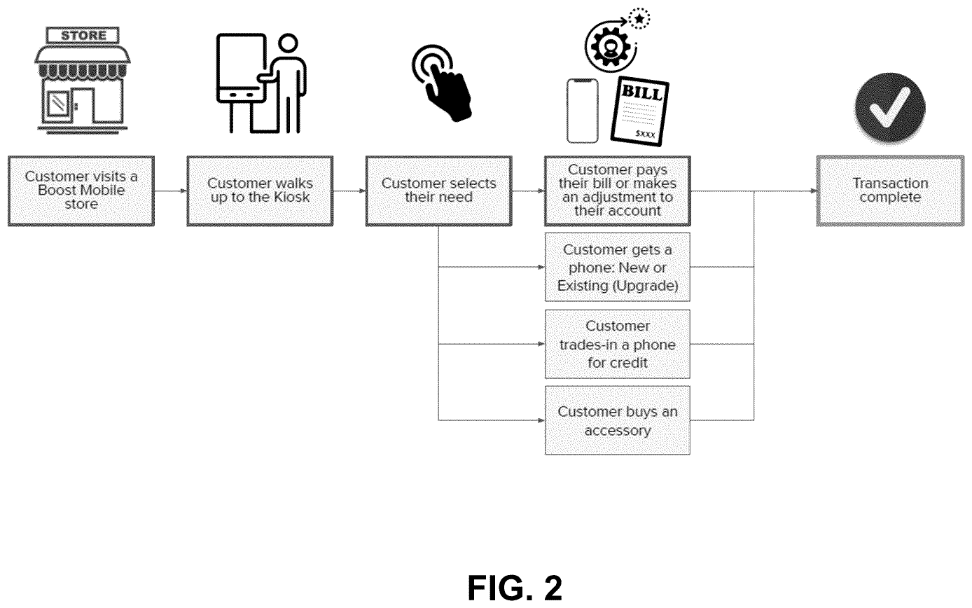

In some embodiments, the activation system 150 may include a data store 157. The data store 157 can also store data involved in the operations of activation system 150. In some embodiments, the activation system 150 can have configuration data, libraries, and other information stored in the data store 157. Although not shown in FIG. 2, the activation system 150 may include additional storage, circuitry or components such as user interfaces, which are necessary for implementing the present disclosure.

In some embodiments, the activation system 150 can receive, from the interaction system 110, instructions to perform an activation regarding UE, where the UE may be retrieved via the interaction system 110 or from the inventory 190. In some embodiments, the activation system 150 may include a robotics component 170. The robotics component 170 may perform various functions described herein to fulfill the request received from the interaction system 110. The robotics component 170 may include a scanning/recording tool 171, a movement tool 173, a processing tool 175, etc. The scanning/recording tool 171 may scan the UE placed in the activation system 150 or record an image or video of the UE to inspect the device. The movement tool 173 may include robotic arms and/or robotic fingers to move the UE and/or interact with the UE to facilitate the performance of activation process or upgrade process. The processing tool 175 may process the data received from the scanning/recording tool 171 and give the instructions to the movement tool 173. The details of the scanning/recording tool 171, the movement tool 173, the processing tool 175 are illustrated below with examples.

In one example, the interaction system 110 may receive, via the user interface unit 112 (e.g., a touch screen), a user request to order a new UE (e.g., a new phone, a new accessory of UE, a physical SIM, etc.). The interaction system 110 may send the user request to the activation system 150. The activation system 150 may process the user request and determine to retrieve a UE with a specific inventory identifier (ID) from the inventory 190. The inventory ID may represent a same type of the UE with a same specification. For example, the inventory ID 1 may represent a cellphone of a first brand in a first version of operating system and a first size of the storage, the inventory ID 2 may represent a cellphone of the first brand in a second version of operating system and the first size of the storage, the inventory ID 3 may represent a cellphone of a second brand in a third version of operating system and a second size of the storage, the inventory ID 4 may represent an earphone of a third brand in a third version of the earphone series, etc.

The activation system 150 may retrieve, via the movement tool 173, a UE with the specific inventory ID. The movement tool 173 may include a robotic arm that can grab a box containing the UE (“UE box”) in the compartment of the inventory 190. The compartment of the inventory 190 may store various UE boxes in an organized manner. For example, the boxes containing UE with inventory ID 1 are stacked one by one in a first column of the compartment of the inventory 190, the boxes containing UE with inventory ID 2 are stacked one by one in a second column of the compartment of the inventory 190, the boxes containing UE with inventory ID 3 are stacked one by one in a third column of the compartment of the inventory 190, etc. The robotic arm may grab the UE box with the specific inventory ID at the top of the corresponding stack at the corresponding column of the compartment of the inventory 190. To identify the correct position of the stack, the processing tool 175 may retrieve the position information from the data store 157, where the position information is recorded initially and updated at the time of removing a UE from or adding a UE to the inventory 190.

The robotic arm may place the grabbed UE box in a first place of the device positioning unit 155. In some implementations, the first place may include a docking station to provide wireless or wired connection, or a unit with scanning technology to identify the UE, including type, brand, version, specification, etc. The robotic arm may unwrap the UE box placed in the first place. For example, the robotic arm may include a knife part to cut off the plastic wrap of the UE box. The robotic arm may place the removed plastic wrap in a disposal unit (not shown) in the activation system 150. The robotic arm may open the UE box by grabbing the cap/top part of the UE box and placing the cap/top part in a box unit (not shown) in the activation system 150, grab the UE from the open UE box, and place the UE in a second place of the device positioning unit 155. The robotic arm may place the bottom part of the box in the box unit in the activation system 150. The box unit may be part of the receiving/delivering unit 114 and used to deliver the empty box to the user in case of the user would like to keep the box.

In some implementations, the movement tool 173 may include one or more robotic fingers to peel off any protective layers around the UE. Peeling off the protective layers around the UE may occur during the robotic arm is grabbing the UE or after the UE is placed in the second place.

In some implementations, the scanning/recording tool 171 may scan the UE placed in the second place to perform a visual inspection of the new UE. For example, the scanning/recording tool 171 may scan the UE and obtain an image or video recording of the UE. The scanning/recording tool 171 may send the image or video recording of the UE to the processing tool 175, where the processing tool 175 may compare the image or video recording of the UE with pre-stored reference data of the image or video recording of the UE. The processing tool 175 may determine whether a defect is identified based on the comparison of the image or video recording of the UE with pre-stored reference data. In some implementations, responsive to determining that a defect is identified, the processing tool 175 may send a notification to the interaction system 110, where the interaction system 110 may notify the vendor or retailor. In some implementations, responsive to determining that a defect is identified, the processing tool 175 may instruct the robotic arm to place the involved UE to a specific location in the compartment of the inventory 190 and grab another new UE similar as described above, where the specific location is used to store the potential defected new UE.

In some implementations, the processing tool 175 may start the activation process of the UE, for example, responsive to determining that no defect is identified. In some implementations, the movement tool 173 may include a robotic finger to interact with the UE for activation. In some implementations, the robotic finger may touch the power button to power up the UE. In some implementations, the robotic finger may touch the touch screen of the UE to setup the basic configuration of the UE, for example, including choosing a language, setting up a Wi-Fi connection, etc. In some implementations, the robotic finger may touch the touch screen of the UE to install a set of default application/software. In some implementations, the robotic finger may touch the touch screen of the UE to set up an account, for example, including the account for data transfer, the account for electronic SIM (eSIM) transfer. In some implementations, the activation system 150 may request, via the interaction system 110, for authorization of setting up the account.

In some embodiments, the activation system 150 can be implemented with a data structure (e.g., stored in the data store 158) that records the activation process corresponding to each UE. The data structure may include a number of records, and each record may include the UE (e.g., inventory ID) and the corresponding activation process (e.g., basic configuration, default application/software, data transfer, account setup, etc.). In some implementations, the data structure can be preset in the activation system 150.

In some implementations, the activation system 150 may test the activated UE for basic functionalities. For example, the activated UE may be a cellphone and the basic functionalities may include voice calling, texting, web browsing, video calling, etc. In one example, the robotic finger may touch the touch screen of the UE to make a call, and the scanning/recording tool 171 may record the process and send to the processing tool 175 to determine whether the call is made successfully.

In some implementations, upon testing the activated UE, the activation system 150 may signal the completion of the activation process of the UE, and command the robotic arm to grab the UE from the second place and place the UE in the receiving/delivering unit 114. The user interface unit 112 may output a notification indicating the completion of the user request.

In another example, the interaction system 110 may receive, via the user interface unit 112 (e.g., a touch screen), a user request to upgrade an old UE (e.g., an old phone). The interaction system 110 may send the user request to the activation system 150. The activation system 150 may process the user request and determine to retrieve the old UE from the receiving/delivering unit 114. For example, the interaction system 110 may output a message on the user interface unit 112, requesting the user to place the old UE in the receiving/delivering unit 114.

The activation system 150 may retrieve, via the movement tool 173, the old UE. The movement tool 173 may include a robotic arm that can grab the old UE from the receiving/delivering unit 114 and place the old UE in a third place of the device positioning unit 155. In some implementations, the third place may include a docking station to provide wireless or wired connection, or a unit with scanning technology to identify the UE, including type, brand, version, specification, etc. For example, upon the old UE is placed in the third place, the processing tool 175 may identify the old UE as a smartphone in a specific brand, version, and specification.

In some implementations, the scanning/recording tool 171 may scan the UE placed in the third place to perform a visual inspection of the UE. For example, the scanning/recording tool 171 may scan the UE and obtain an image or video recording of the UE. The scanning/recording tool 171 may send the image or video recording of the UE to the processing tool 175, where the processing tool 175 may compare the image or video recording of the UE with pre-stored reference data of the image or video recording of the UE. The processing tool 175 may determine whether a defect is identified based on the comparison of the image or video recording of the UE with pre-stored reference data. In some implementations, responsive to determining that a defect is identified, the processing tool 175 may send a notification to the interaction system 110, where the interaction system 110 may notify the user. In some implementations, responsive to determining that a defect is identified, the processing tool 175 may output, via the user interface unit 112, a notification indicates the UE has a defect and is sent back in the receiver/delivering unit 114.

In some implementations, the processing tool 175 may start the upgrade process of the UE, for example, responsive to determining that no defect is identified. In some implementations, the movement tool may include a robotic finger to interact with the UE for upgrade. In some implementations, the robotic finger may touch the power button to power up the UE. In some implementations, the robotic finger may touch the touch screen of the UE to upgrade the basic configuration of the UE, for example, including operating system, etc. In some implementations, the robotic finger may touch the touch screen of the UE to upgrade a set of default application/software. In some implementations, the robotic finger may touch the touch screen of the UE to upgrade an account, for example, including the account for data transfer, the account for electronic SIM (eSIM) transfer. In some implementations, the activation system 150 may request, via the interaction system 110, for authorization of upgrading the account.

In some implementations, the activation system 150 may test the upgraded UE for basic functionalities and/or upgraded functionalities. For example, the activated UE may be a cellphone, the basic functionalities may include voice calling, texting, web browsing, video calling, etc., and the upgraded functionalities may include a service provided by an application. For example, the robotic finger may touch the touch screen of the UE to make a call or use the application, and the scanning/recording tool 171 may record the process and send to the processing tool 175 to determine whether the call or the service provided by the application is made successfully.

In some implementations, upon testing the upgraded UE, the activation system 150 may signal the completion of the updating process of the UE, and command the robotic arm to grab the UE from the third place and place the UE in the receiving/delivering unit 114. The user interface unit 112 may output a notification indicating the completion of the user request.

In yet another example, the interaction system 110 may receive, via the user interface unit 112 (e.g., a touch screen), a user request to order a new UE with an option of an old UE trade-in. For example, the interaction system 110 may send the user request to the activation system 150. The activation system 150 may process the user request and determine to retrieve the trade-in UE from the receiving/delivering unit 114. For example, the interaction system 110 may output a message on the user interface unit 112, requesting the user to place the trade-in UE in the receiving/delivering unit 114.

The activation system 150 may retrieve, via the movement tool 173, the trade-in UE. The movement tool 173 may include a robotic arm that can grab the trade-in UE and place the grabbed UE box in a fourth place of the device positioning unit 155. In some implementations, the fourth place may include a docking station to provide wireless or wired connection, or a unit with scanning technology to identify the trade-in UE, including type, brand, version, specification, etc. In some implementations, the scanning/recording tool 171 may scan the UE placed in the fourth place to perform a visual inspection of the trade-in UE (e.g., to determine whether a defect is identified).

In some implementations, the activation system 150 may determine whether the trade-in UE is a qualified product for trade in. In some implementations, the activation system 150 may determine whether the trade-in UE is a qualified product for trade in, based on the identified trade-in UE (e.g., type, brand, version, specification, etc.) and/or the visual inspection of the trade-in UE (e.g., identified defect). In some implementations, the data store 157 stores the information of the qualified product for trade in, including type, brand, version, specification, and the extent to which the defect can be. Upon determining whether the trade-in UE is a qualified product for trade in, the activation system 150 may output, via the user interface unit 112, a notification regarding the determination and request the user's authorization to continue with the order of the new UE. The notification may also include an option for realizing the value of the qualified trade-in UE, including prepaid gift card, merchandise credit, etc.

As described above, the interaction system 110 may send the user request to the activation system 150. The activation system 150 may process the user request and determine to retrieve a UE with a specific inventory identifier (ID) from the inventory 190. The activation system 150 may retrieve, via the movement tool 173, a UE with the specific inventory ID. The movement tool 173 may include a robotic arm that can grab a box containing the UE (“UE box”) in the compartment of the inventory 190. The robotic arm may place the grabbed UE box in a fifth place of the device positioning unit 155. The robotic arm may unwrap the UE box placed in the fifth place. The robotic arm may open the UE box by grabbing the cap/top part of the UE box and placing the cap/top part in a box unit (not shown) in the activation system 150, grab the UE from the open UE box, and place the UE in a sixth place of the device positioning unit 155. In some implementations, the movement tool 173 may include one or more robotic fingers to peel off any protective layers around the UE. In some implementations, the scanning/recording tool 171 may scan the UE placed in the sixth place to perform a visual inspection of the new UE.

In some implementations, the processing tool 175 may start the activation process of the UE. In some implementations, the movement tool 173 may include a robotic finger to interact with the UE for activation. In some implementations, the robotic finger may touch the power button to power up the UE. In some implementations, the robotic finger may touch the touch screen of the UE to setup the basic configuration of the UE, for example, including choosing a language, setting up a Wi-Fi connection, etc. In some implementations, the robotic finger may touch the touch screen of the UE to install a set of default application/software. In some implementations, the robotic finger may touch the touch screen of the UE to synchronize the data and transfer the data from the old UE to the new UE. In some implementations, the robotic finger may touch the touch screen of the UE to set up an account, for example, including the account for data transfer, the account for electronic SIM (eSIM) transfer. In some implementations, the activation system 150 may request, via the interaction system 110, for authorization of setting up the account or transferring the data.

In some implementations, the activation system 150 may test the activated UE for basic functionalities. In some implementations, upon testing the activated UE, the activation system 150 may signal the completion of the activation process of the UE, and command the robotic arm to grab the UE from the sixth place and place the UE in the receiving/delivering unit 114. The user interface unit 112 may output a notification indicating the completion of the user request.

In some implementations, the exterior of the activation system 150 may be transparent such that the user is able to see the activation process or the upgrade process of the UE. In some implementations, the activation system 150 may provide a live-video of the activation process or the upgrade process of the UE to be displayed via the user interface unit 112.

FIG. 2 illustrates an example process to use the automated activation machine for user equipment that can be used in a cellular network. As shown in FIG. 2, the customer or user may visit a retail store for user equipment that can be used in a cellular network. The customer or user may proceed to an automated activation machine (e.g., the system 100) in the retail store and select, via the user interface component (e.g., user interface unit 112), a request among a list of the requests. The requests may include paying bill or making an adjustment to user's account, purchasing a UE (e.g., new phone, refurbished phone, accessory, etc.), trading in an old UE, upgrading an old UE, etc. The automated activation machine (e.g., the system 100) may perform an activation process or an upgrade process according to the request as described above, and complete the request by delivering the corresponding UE.

In some implementations, a system (e.g., system 100 in FIG. 1) may include a computing system, and the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a system 100 (e.g., the system 100 of FIG. 1).

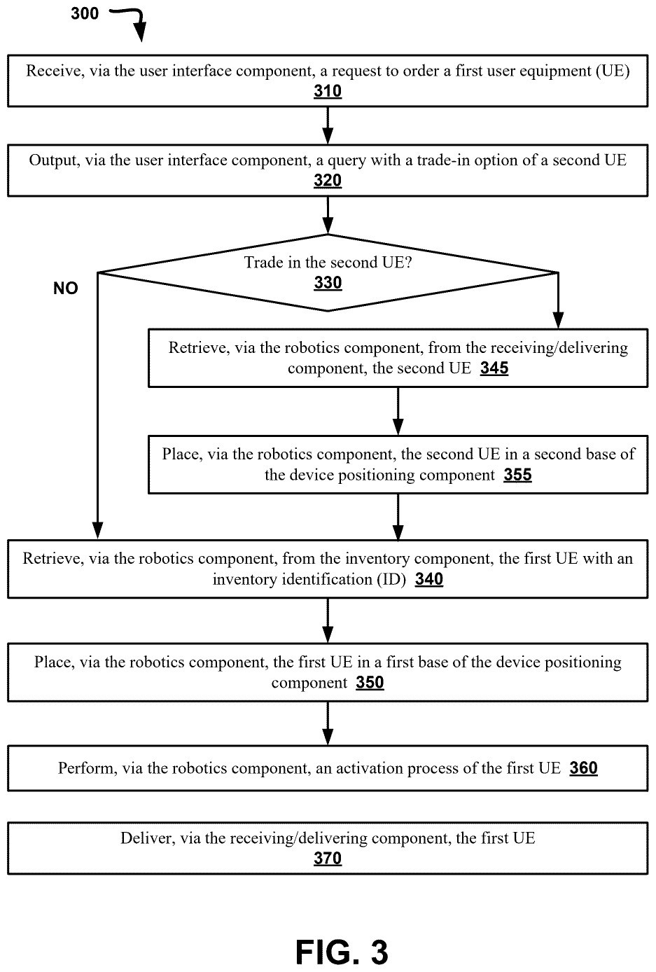

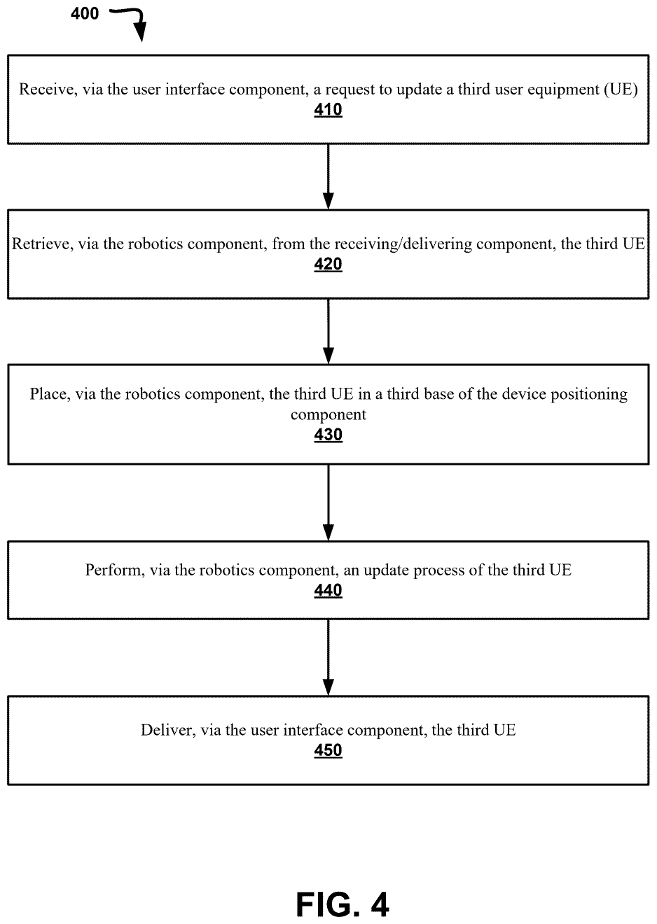

FIGS. 3 and 4 are flow diagrams of methods 300 and 400 of implementing automated activation machine for user equipment that can be used in a cellular network according to at least one embodiment. The methods 300 and 400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 300 and 400 are performed by the system 100 of FIG. 1.

Referring to FIG. 3, at operation 310, the processing logic may receive, via the user interface component (e.g., the user interface unit 112), a request to order a first user equipment (UE). At operation 320, the processing logic may output, via the user interface component (e.g., the user interface unit 112), a query with a trade-in option of a second UE.

At operation 330, the processing logic may determine whether the second UE is to be traded in. In some implementations, the processing logic may receive, via the user interface component (e.g., the user interface unit 112), an instruction of the trade-in option of the second UE, and the processing logic may determine whether the second UE is to be traded in according to the instruction. At operation 345, responsive to determining that the second UE is to be traded in, the processing logic may retrieve, via the robotics component (e.g., the robotics component 170), from the receiving/delivering component (e.g., the receiving/delivering unit 114), the second UE. At operation 355, the processing logic may place, via the robotics component (e.g., the robotics component 170), the second UE in a second place of the device positioning component.

At operation 340, the processing logic may retrieve, via the robotics component (e.g., the robotics component 170), from the inventory component (e.g., inventory 190), the first UE with an inventory identifier (ID). In some implementations, responsive to determining that the second UE is not to be traded in, the processing logic may retrieve, via the robotics component (e.g., the robotics component 170), from the inventory component (e.g., inventory 190), the first UE with an inventory identifier (ID).

At operation 350, the processing logic may place, via the robotics component (e.g., the robotics component 170), the first UE in a first place of the device positioning component. In some implementations, the processing logic may retrieve, via the robotics component (e.g., the robotics component 170), from the inventory component, a first box marked with the inventory ID, wherein the inventory component store a plurality of boxes marked with the inventory ID, and wherein the plurality of boxes comprises the first box. In some implementations, the processing logic may unwrap, via the robotics component (e.g., the robotics component 170), the first box, unbox, via the robotics component (e.g., the robotics component 170), the first box, and retrieve, via the robotics component (e.g., the robotics component 170), the first UE from the first box. In some implementations, the processing logic may peel off, via the robotics component (e.g., the robotics component 170), a protective layer of the first UE, scan, via the robotics component (e.g., the robotics component 170), the first UE, and determine whether the first UE has a visual defect based on the scanning, wherein the activation process of the first UE is performed responsive to determining that the first UE has no visual defect. In some implementations, responsive to determining that the first UE has the visual defect, the processing logic may retrieve, via the robotics component (e.g., the robotics component 170), from the inventory component (e.g., inventory 190), a new UE to be used as the first UE.

At operation 360, the processing logic may perform, via the robotics component (e.g., the robotics component 170), an activation process of the first UE. In some implementations, to perform the activation process, the processing logic may power up the first UE, set up a basic configuration of the first UE, and install a set of default applications or software. In some implementations, to perform the activation process, the processing logic may set up an account associated with the first UE and install a set of customized applications or software according to the account. In some implementations, to perform the activation process, the processing logic may transfer data from the second UE to the first UE. At operation 370, the processing logic may deliver, to the receiving/delivering component (e.g., the receiving/delivering unit 114), the first UE.

Referring to FIG. 4, at operation 410, the processing logic may receive, via the user interface component (e.g., the user interface unit 112), a request to upgrade a third user equipment (UE). At operation 420, the processing logic may retrieve, via the robotics component (e.g., the robotics component 170), from the receiving/delivering component, the third UE. At operation 430, the processing logic may place, via the robotics component (e.g., the robotics component 170), the third UE in a third base of the device positioning component. At operation 440, the processing logic may perform, via the robotics component (e.g., the robotics component 170), an upgrade process of the third UE. At operation 450, the processing logic may deliver, to the user interface component (e.g., the receiving/delivering unit 114), the third UE.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A system comprising:
a user interface component;
a receiving/delivering component;
a robotics component;
a device positioning component;
an inventory component;
one or more processing devices; and
a memory communicatively coupled with and readable by the one or more processing devices and having stored therein processor-readable instructions which, when executed by the one or more processing devices, cause the one or more processing devices to perform operations comprising:
receiving, via the user interface component, a request to order a first user equipment (UE);
retrieving, via the robotics component, from the inventory component, the first UE according to an inventory identifier (ID);
placing, via the robotics component, the first UE at a first place of the device positioning component;
performing, via the robotics component, an activation process of the first UE; and
delivering, via the robotics component, to the receiving/delivering component, the first UE.

2. The system of claim 1, wherein performing the activation process of the first UE further comprises:
powering up the first UE;
setting up a basic configuration of the first UE; and
installing a set of default applications or software on the first UE.

3. The system of claim 2, wherein performing the activation process of the first UE further comprises:
setting up an account associated with the first UE; and
installing a set of customized applications or software on the first UE according to the account.

4. The system of claim 1, wherein the operations further comprise:
outputting, via the user interface component, a query with a trade-in option of a second user equipment (UE); and
receiving, via the user interface component, an instruction of the trade-in option of the second UE.

5. The system of claim 4, wherein the operations further comprise:
responsive to receiving the instruction to trade in the second UE, retrieving, via the robotics component, from the receiving/delivering component, the second UE; and
placing, via the robotics component, the second UE at a second place of the device positioning component.

6. The system of claim 5, wherein performing the activation process of the first UE further comprises:
transferring data from the second UE to the first UE.

7. The system of claim 1, wherein retrieving, via the robotics component, from the inventory component, the first UE according to the inventory ID further comprises:
retrieving, via the robotics component, from the inventory component, a first box marked with the inventory ID, wherein the inventory component store a plurality of boxes marked with the inventory ID, and wherein the plurality of boxes comprises the first box;
unwrapping, via the robotics component, the first box;
unboxing, via the robotics component, the first box; and
retrieving, via the robotics component, the first UE from the first box.

8. The system of claim 1, wherein the operations further comprise:
peeling off, via the robotics component, a protective layer of the first UE;
scanning, via the robotics component, the first UE; and
determining whether the first UE has a visual defect based on the scanning,
wherein the activation process of the first UE is performed responsive to determining that the first UE has no visual defect.

9. The system of claim 8, wherein the operations further comprise:
responsive to determining that the first UE has the visual defect, retrieving, via the robotics component, from the inventory component, a new UE to be used as the first UE.

10. A method to implement automated activation machine for user equipment that can be used in a cellular network, the method comprising:
receiving, via a user interface component of the automated activation machine, a request to order a first user equipment (UE);
retrieving, via a robotics component of the automated activation machine, from an inventory component of the automated activation machine, the first UE according to an inventory identifier (ID);
placing, via the robotics component, the first UE at a first place of a device positioning component of the automated activation machine;
performing, via the robotics component, an activation process of the first UE; and
delivering, via the robotics component, to a receiving/delivering component of the automated activation machine, the first UE.

11. The method of claim 10, wherein performing the activation process of the first UE further comprises:
powering up the first UE;
setting up a basic configuration of the first UE; and
installing a set of default applications or software on the first UE.

12. The method of claim 11, wherein performing the activation process of the first UE further comprises:
setting up an account associated with the first UE; and
installing a set of customized applications or software on the first UE according to the account.

13. The method of claim 10, wherein retrieving, via the robotics component, from the inventory component, the first UE according to the inventory ID further comprises:
retrieving, via the robotics component, from the inventory component, a first box marked with the inventory ID, wherein the inventory component store a plurality of boxes marked with the inventory ID, and wherein the plurality of boxes comprises the first box;
unwrapping, via the robotics component, the first box;
unboxing, via the robotics component, the first box; and
retrieving, via the robotics component, the first UE from the first box.

14. The method of claim 10, further comprising:
peeling off, via the robotics component, a protective layer of the first UE;
scanning, via the robotics component, the first UE; and
determining whether the first UE has a visual defect based on the scanning,
wherein the activation process of the first UE is performed responsive to determining that the first UE has no visual defect.

15. The method of claim 14, further comprising:
responsive to determining that the first UE has the visual defect, retrieving, via the robotics component, from the inventory component, a new UE to be used as the first UE.

16. One or more non-transitory, computer-readable storage media having computer-readable instructions thereon which, when executed by one or more processing devices, cause the one or more processing devices to perform operations comprising:
receiving, via a user interface component of an automated activation machine, a request to order a first user equipment (UE);
retrieving, via a robotics component of the automated activation machine, from an inventory component of the automated activation machine, the first UE according to an inventory identifier (ID);
placing, via the robotics component, the first UE at a first place of a device positioning component of the automated activation machine;
performing, via the robotics component, an activation process of the first UE; and
delivering, via the robotics component, to a receiving/delivering component of the automated activation machine, the first UE.

17. The one or more non-transitory, computer-readable storage media of claim 16, wherein performing the activation process of the first UE further comprises:
powering up the first UE;
setting up a basic configuration of the first UE; and
installing a set of default applications or software on the first UE.

18. The one or more non-transitory, computer-readable storage media of claim 16, wherein performing the activation process of the first UE further comprises:
setting up an account associated with the first UE; and
installing a set of customized applications or software on the first UE according to the account.

19. The one or more non-transitory, computer-readable storage media of claim 16, wherein retrieving, via the robotics component, from the inventory component, the first UE according to the inventory ID further comprises:
retrieving, via the robotics component, from the inventory component, a first box marked with the inventory ID, wherein the inventory component store a plurality of boxes marked with the inventory ID, and wherein the plurality of boxes comprises the first box;
unwrapping, via the robotics component, the first box;
unboxing, via the robotics component, the first box; and
retrieving, via the robotics component, the first UE from the first box.

20. The one or more non-transitory, computer-readable storage media of claim 16, wherein the operations further comprise:
peeling off, via the robotics component, a protective layer of the first UE;
scanning, via the robotics component, the first UE; and
determining whether the first UE has a visual defect based on the scanning,
wherein the activation process of the first UE is performed responsive to determining that the first UE has no visual defect.
